(19) United States
(12) Patent Application Publication
(10) Pub. No.: US 2014/0033524 A1
(43) Pub. Date: Feb. 6, 2014

(54) WIRE HARNESS MANUFACTURING METHOD

(71) Applicants: Osamu Sato, Yokkaichi-shi (JP); Nobuyuki Hirano, Yokkaichi-shi (JP); Atsushi Murata, Yokkaichi-shi (JP)

(72) Inventors: Osamu Sato, Yokkaichi-shi (JP); Nobuyuki Hirano, Yokkaichi-shi (JP); Atsushi Murata, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/583,029

(22) PCT Filed: Apr. 26, 2011
(86) PCT No.: PCT/JP2011/060115

§ 371 Date: Sep. 6, 2012

(51) Int. Cl. H01B 13/012

(52) U.S. Cl. CPC H01B 13/012
USPC 29/825

(57) ABSTRACT

A sheet-like member (14) is wound around an outer circumferential surface of a predetermined portion of a wire bundle (12) of a wire harness (1), and both side parts (141, 142) of the sheet-like member (14) are superposed on an outer circumferential surface of a predetermined portion of the wire bundle (12). A jig (5) is disposed between the outer circumferential surface of the predetermined portion of the wire bundle (12) and an inner circumferential surface of the superposed side parts (141, 142) of the sheet-like member (14). A pressurizing member (6) of an ultrasonic welder pressurizes at least part of the superposed portion of the sheet-like member (14) for ultrasonic welding, thereby forming a protector (13) from the sheet-like member (14) on the outer circumferential surface of the predetermined portion of the wire bundle (12).

### BACKGROUND OF THE INVENTION

1. Field of the Invention

The present invention relates to a wire harness manufacturing method and, in detail, to a method of manufacturing a wire harness provided with a protector protecting a wire (a single wire or a group of a plurality of wires) configuring the wire harness.

2. Description of the Related Art

Inside a vehicle such as an automobile, wire harnesses for interconnecting electric and electronic devices and others are routed. A wire harness is formed by binding wires of a predetermined type into a predetermined shape. On a predetermined portion of the wires configuring a wire harness, a protector may be mounted in order to prevent damages due to a load from outside or the like.

There are various structures of protector. For example, a shell-like molded product with a hollow inside is widely used. According to a structure to which a molded protector is applied, a wire is accommodated in an inner space of the protector, thereby preventing exertion of a load from outside to the wire. With this, damage to the wire or the like can be prevented. However, the structure to which a molded protector is applied has the following problems.

First, to manufacture a molded protector, a mold is required. The mold is expensive in general, thereby inviting an increase in manufacturing cost and price of the protector and, as a result, also possibly inviting an increase in price of a wire harness. Furthermore, in the structure in which a wire is accommodated in a shell-like molded protector, a gap may be present between the inner circumferential surface of the protector and the wire. For this reason, if vibration, shock, or the like is applied to the wire harness, the wire collides with the inner circumferential surface of the protector, thereby possibly producing a collision sound. Such a collision sound may be recognized by a user as an unusual sound, and therefore the quality of a product to which this wire harness is applied (such as a vehicle in which this wire harness is routed) may be degraded. Moreover, a shock hits the wire due to collision of the wire with the inner circumferential surface of the protector to possibly damage the wire.

As a structure in which a non-molded protector is used, the structure as described in JP H11 (1999)-7856 A may be used. In the structure described in JP H11 (1999)-7856 A, a sheet component is wound around a wire group configuring a wire harness, superfluous portions of the wound sheet component are superposed so as to be laminated together, and then the superposed portion is pressurized and heated by a thermo compression machine for welding. According to this structure, the sheet component wound around the wire group serves as a protector protecting the wire group. Since the sheet component is inexpensive compared with the molded product, a reduction in component cost can be achieved, compared with the structure to which a molded protector is applied.

In the structure described above, however, a welded portion (=a superfluous portion) of the sheet component protrudes outward from the surface of the wire group, the outer dimensions of the protector is increased. For this reason, the superfluous portion may obstruct the routing operation when, for example, a wire harness is routed in a narrow place.

As a structure in which the welded portion does not protrude from the outer circumferential surface of the wire group, for example, the structure described in JP H9 (1997)-298015 A has been suggested. In the structure described in JP H9 (1997)-298015, a wire group configuring a wire harness is covered with a flexible sheet, both of side parts of this flexible sheet are superposed on the outer circumferential surface of the wire group, a hot-melt bonding agent is applied to this superposed portion and then, in this state, the wire group and the flexible sheet are pressurized by a hot-press machine while being heated. When the superposed portion of the flexible sheet is pressurized and heated, that superposed portion is bonded with the hot-melt bonding agent.

According to the structure of JP H9 (1997)-298015, the bonding part of the flexible sheet is formed along the outer circumferential surface of the wire group. For this reason, the bonding part does not protrude from the outer circumferential surface of the wire group. However, the structure described in JP H9 (1997)-298015 has the following problems.

First, not only the superposed portion of the flexible sheet but also the wire group configuring the wire harness is pressurized and heated by the hot-press machine. Each wire configuring the wire harness is configured to have a conductor coated with a coating component, and the coating component is formed from a thermoplastic resin composite. For this reason, when the wire group is heated, the coating component of each wire is damaged by heat, thereby possibly causing a function of protecting and insulating the conductor to be degraded or lost.

Also, in the structure of JP H9 (1997)-298015, only the superposed portion of the flexible sheet is directly pressurized by a pressing mold of the hot-press machine, but one side part of the flexible sheet configuring the superposed portion is indirectly pressurized via the wire group. For this reason, when the wire group is deformed at the time of pressurizing, a sufficient pressure may not be applied to the superposed portion of the flexible sheet. For this reason, the superposed portion of the flexible sheet is not sufficiently bonded, thereby decreasing the bonding strength. If the applied pressure is increased to improve the bonding strength, the pressurizing force to be applied to the wire group is also increased, thereby possibly damaging the wire group.

Furthermore, the pressure applied to the superposed portion of the flexible sheet at the time of pressurizing may be influenced by the form of deformation of the wire group. However, it is difficult to control deformation of the wire group to be uniform, and therefore the pressure applied to the superposed portion of the flexible sheet may become nonuniform. As a result, the bonding strength of the superposed portion may become nonuniform.

### SUMMARY OF INVENTION

The problems will be solved by the present invention by providing a wire harness manufacturing method capable of decreasing the size of a protector mounted around a wire (including both of a single wire and a bundle of a plurality of wires) for protection thereof, providing a wire harness manufacturing method capable of preventing a decrease in bonding strength at a bonding part of a sheet material configuring the protector or improving the bonding strength, or providing a wire harness manufacturing method capable of, while achieving a structure in which the bonding part of the sheet material configuring the protector does not protrude outward, preventing a decrease in bonding strength at the bonding part or improving the bonding strength.

To solve the problems described above, a wire harness manufacturing method according to the present invention includes the steps of: winding a sheet-like member around an outer circumferential surface of a predetermined portion of a wire (including a wire bundle formed from a plurality of wires, in addition to a single wire), and superposing both of side parts of the sheet-like member on a portion on an outer circumferential surface of a predetermined portion of the wire; and disposing a jig between the outer circumferential surface of the predetermined portion of the wire and an inner circumferential surface of the superposed portion of the sheet-like member and pressurizing and welding at least part of the superposed portion of the sheet-like member by a pressurizing member of a welder.

Note that it is assumed that the “outer circumferential surface of the wire” refers to, in the case of a single wire, an outer circumferential surface of the outmost member of the single wire (in general, the outer circumferential surface of a coating component) or, in the case of a wire bundle formed from a plurality of wires, to an outer circumferential surface of a substance as which the wire bundle is regarded (however, an outer circumferential surface of a modeled substance with fine asperities formed due to each wire and a gap between wires being ignored).

As the welder, an ultrasonic welder can be applied. In this case, as the sheet-like member, a member made of an ultrasonically-weldable material can be applied. And, the structure can be applied in which ultrasonic vibrations are provided for welding while at least part of the superposed portion of the sheet-like member is being pressurized.

As the jig, a flat plate or an approximately stick-like member having an arc-shaped section along a shape of the outer circumferential surface of the wire can be applied, which has a predetermined length in an axial direction of the wire.

The jig may be configured to be disposed in advance on the outer circumferential surface of the predetermined portion of the wire before the sheet-like member is wound around the predetermined portion of the wire, and the sheet-like member may be configured to have both of the side parts superposed on an outer circumferential surface of the jig.

Also, the jig may be configured to be inserted between the outer circumferential surface of the predetermined portion of the wire and the inner circumferential surface of the superposed portions of the sheet-like member after the sheet-like member is wound around the outer circumferential surface of the predetermined portion of the wire.

According to the present invention, a portion where parts of the sheet-like member configuring a protector are superposed (=a portion where a bonding part is formed) can be formed along the outer circumferential surface of the wire. For this reason, a protector without having a portion protruding outward can be formed. Therefore, the size of the protector can be decreased.

According to the wire harness manufacturing method of the embodiments of the present invention, in a process of bonding both of the side parts of the sheet-like member, at least part of both of the side parts of the sheet-like member is pressurized as being interposed between a pressurizing member of the welder (when the welder is an ultrasonic welder, a horn of the ultrasonic welder) and the jig. For this reason, a predetermined pressure can be applied to a predetermined portion (that is, a portion serving as the bonding part) of the sheet-like member. With this, compared with the structure in which a jig is not used, the pressure to be applied to the sheet-like member can be increased, thereby improving the bonding strength at the bonding part. Furthermore, since the applied pressure can be easily controlled, when a plurality of parts are bonded in sequence, a uniform pressure can be applied to all parts, thereby making the bonding strength uniform. Therefore, the quality of the wire harness is stabilized, and quality control is facilitated.

According to the wire harness manufacturing method of the embodiments of the present invention, the surface of the wire configuring the wire harness is heated by heat transfer, but its temperature increase is small, and the coating component of the wire is not damaged. Therefore, the function of the coating component of the wire for protecting and insulating a conductor is not degraded or lost. Furthermore, when both of the side parts of the sheet-like member are bonded together, the wire is not pressurized, thereby preventing the wire from being damaged by the applied pressure. Therefore, reliability of the wire harness can be kept.

Also, according to the wire harness manufacturing method of the embodiments of the present invention, the portion where both of the side parts of the sheet-like member are superposed is formed along and over the outer circumferential surface of the wire bundle. For this reason, while it is required to remove (=trim) an unnecessary portion after bonding in a conventional structure in which the portion where both of the side parts of the sheet-like member are superposed is configured to protrude outward, this process is not required in the wire harness manufacturing method according to the embodiments of the present invention. Therefore, a reduction in the number of manufacturing processes and a reduction in manufacturing cost can be achieved.

Furthermore, according to the present invention, while a structure is achieved in which a bonding part of the material configuring the protector does not protrude outward, a decrease in bonding strength at the bonding part can be prevented or the bonding strength can be improved.

### BRIEF DESCRIPTION OF DRAWINGS

FIG. 1 shows views each schematically showing the structure of a wire harness manufactured by using a wire harness manufacturing method according to an embodiment of the present invention, FIG. 1(a) being an external perspective view of a part extracted therefrom and FIG. 1(b) being an A-A-line sectional view of FIG. 1(a) schematically showing a sectional structure.

FIG. 2 shows views each schematically showing the structure of a jig for use in the wire harness manufacturing method according to the embodiment of the present invention, FIG. 2(a) being an external perspective view of the jig and FIG. 2(b) being a perspective view showing the state in which the jig is disposed between an outer circumferential surface of a wire bundle and an inner circumferential surface of a protector (=a sheet-like member).

FIG. 3 shows schematic sectional views schematically showing a predetermined process of a protector manufacturing method according to an embodiment of the present invention, FIG. 3(a) being a view showing the state before the sheet-like member is wound around the wire bundle and FIG. 3(b) being a view showing the state in which the sheet-like member is wound around the wire bundle.

FIG. 4 shows schematic sectional views schematically showing the predetermined process of a protector manufacturing method according to the embodiment of the present invention, FIG. 4(a) being a view showing the state in which a sheet-like member is wound around a wire bundle 12 and FIG. 4(b) being a view showing the state in which a jig 5 is inserted between an outer circumferential surface of the wire bundle 12 and the sheet-like member 14.

FIG. 5 shows schematic sectional views schematically showing the predetermined process of the protector manufacturing method according to the embodiment of the present invention, FIG. 5(a) being a view showing a process of welding one side part and the other side part of the sheet-like member together by an ultrasonic welder and FIG. 5(b) being a view of the state in which welding is complete.

### DETAILED DESCRIPTION OF THE PREFERRED EMBODIMENTS

Embodiments of the present invention are described in detail below with reference to the drawings.

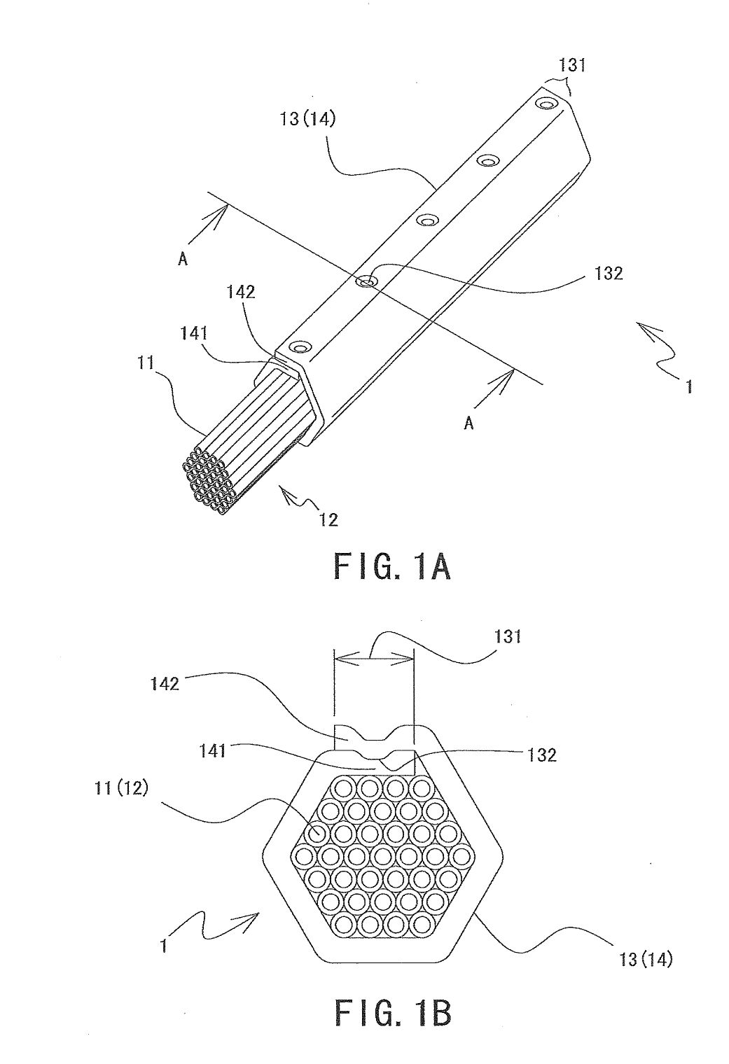

FIG. 1 shows views each schematically showing the structure of a wire harness 1 manufactured by using a wire harness manufacturing method according to an embodiment of the present invention. FIG. 1(a) is an external perspective view of a part extracted therefrom and FIG. 1(b) being an A-A-line sectional view of FIG. 1(a) schematically showing a sectional structure. In the following, the wire harness manufactured by using the wire harness manufacturing method of the present invention may be referred to as a “present wire harness”.

The present wire harness 1 configures, as a whole, a wire bundle 12 with a predetermined number of wires 11 of a predetermined type being gathered, and the wire bundle 12 is configured to be formed in a predetermined shape. On an end of each of the wires 11 configuring the wire bundle 12 of the present wire harness 1, a predetermined connector or the like is mounted (not shown). And, as shown in FIGS. 1(a) and 1(b), a protector 13 is provide on an outer circumferential surface of a predetermined portion of the wire bundle 12 of the present wire harness 1. Note that while the protector 13 is provided on a portion desired to be protected on the wire bundle 12 of the present wire harness 1, the protector may be configured to be provided on either part or entire of the wire bundle 12 of the present wire harness 1.

Note that it is assumed that the “outer circumferential surface of the wire bundle 12” refers to an outer circumferential surface of a single substance as which the wire bundle 12 is regarded (however, an outer circumferential surface of a modeled substance with fine asperities formed due to each wire 11 and a gap between wires 11 being ignored).

The protector 13 is formed from a sheet-like member 14 made of a ultrasonically-weldable material (that is, a thermoplastic material). For example, a sheet, a non-woven fabric, a foam, or the like can be applied.

A non-woven fabric to be applied may have a structure in which a base fiber and a binder fiber are intertwined with each other. The base fiber is formed from a thermoplastic resin composite having a predetermined melting point. The binder fiber has a structure in which a layer of a binder component is formed around an outer circumference of a core fiber. This core fiber is formed from the same thermoplastic resin composite as the base fiber. The layer of the binder component is formed from a thermoplastic resin composite having a melting point lower than those of the base fiber and the core fiber. When the above-configured non-woven fiber is heated to a temperature higher than the melding point of the binder component and lower than the melding point of the base fiber, the base fiber and the core fiber are not molten and their fiber state is kept, but the binder component is molten.

For this reason, when, with the non-woven fibric being brought into contact and pressurized so as to be superposed, a portion brought into contact and pressurized is provided with ultrasonic vibrations and is also heated to a temperature lower than the melting point of the base fiber and the core fiber of the binder fiber and equal to or higher than the melting point of the binder component, the binder component is molten to be transfused between the base fiber and the core fiber. After that, when the temperature returns to a temperature lower than the temperature described above, the molten binder component becomes solidified to couple the base fiber and the core fiber together. For this reason, the portion brought into contact and pressurized is bonded (=welded).

The material of the base fiber and the core fiber of the binder fiber and the material of the binder component of the binder fiber of the non-woven fabric are not particularly restrictive as long as the material can satisfy the conditions described above. For example, a non-woven fabric configured to have a base fiber made of PET (polyethylene terephthalate), a core fiber of a binder fiber made of PET, and a binder component of the binder fiber made of a copolymer resin of PET and PEI (polyethylene isophthalate) can be applied. In this structure, the melting point of the base fiber and the core fiber (that is, PET) is approximately 250° C., and the melting point of the binder component is 110° C. to 150° C. For this reason, when this non-woven fabric is heated to 110° C. to 150° C., the base fiber and the core fiber are not molten to keep a fiber shape, but the binder component is molten to be transfused between the base fiber and the core fiber. Thereafter, when the temperature returns to a temperature lower than the temperature described above, the binder component is solidified to bind the base fiber and the core fiber together.

The protector 13 has a structure in which the sheet-like member 14 is wound around the outer circumferential surface of the wire bundle 12. In other words, with the sheet-like member 14 being wound around the outer circumferential surface of the wire bundle 12, the protector 13 is formed.

A superposed part 131 is formed on the protector 13. The superposed part 131 is a portion where one side part 141 of the sheet-like member 14 and the other side part 142 thereof are superposed on the outer circumferential surface of the wire bundle 12. Specifically, the superposed part 131 is formed with the one side part 141 of the sheet-like member 14 being disposed along the outer circumferential surface of the wire bundle 12 and the other side part 142 being superposed on the outside of the one side part 141. For this reason, in the superposed part 131, an outer surface of the one side part 141 of the sheet-like member 14 (=a surface opposite to the wire bundle 12) and an inner surface of the other side part 142 (=a surface on a wire bundle 12 side) face each other (or are in contact with each other), a the outer surface of the one side part 141 and the inner surface of the other side part 142 are approximately parallel to the outer circumferential surface of the wire bundle 12. That is, the superposed part 131 is formed along the outer circumferential surface of the wire bundle 12, and the superposed part 131 (that is, both of the side parts 141 and 142 of the sheet-like member 14) does not protrude away from the outer circumferential surface of the wire bundle 12.

A bonding part 132 is formed on the superposed part 131. The bonding part 132 is a portion where an outer surface of one side part 141 of the sheet-like member 14 and an inner surface of the other side part 142 thereof are bonded together, and is a portion welded by ultrasonic welding. For this reason, the protector 13 has an approximately cylindrical structure as a whole. Inside the protector 13, the wire bundle 12 is accommodated. According to this structure, the wire bundle 12 is protected by the protector 13.

Note that the structure may be such that the bonding part 132 is formed on the protector 13 throughout the length of the wire bundle 12 in the axial direction (the structure in which both of the side parts 141 and 142 of the sheet-like member 14 are bonded without a gap throughout the length of the wire bundle 12 in the axial direction) or such that a plurality of bonding parts 132 are formed with a predetermined space away from each other (the structure in which the sheet-like member 14 is partially bonded along the axial direction of the wire bundle 12). FIG. 1(a) shows the state in which the bonding parts 132 are formed with a predetermined space away from each other.

As such, in the present wire harness 1, the superposed part 131 and the bonding part 132 of the sheet-like member 14 configuring the protector 13 are formed along the outer circumferential surface of the wire bundle 12. For this reason, the superposed part 131 of the sheet-like member 14 configuring the protector 13 is configured not to protrude outward from another portion of the protector 13. Therefore, the size of the protector 13 can be decreased (in particular, the dimensions and shape of a section cutting out along a plane approximately at a right angle with respect to the axial direction of the wire bundle 12 can be decreased), and routing can be made in an narrow space. And, a portion protruding outward from the outer circumferential surface of the wire bundle 12 is not formed, and therefore the present wire harness 1 can be conveniently handled. That is, if a portion protruding outward is present on the protector 13, this protruding portion may get snagged on another substance or the like to inhibit the routing operation or the like, but such cases do not occur in the present wire harness 1.

Next, a protector manufacturing method according to an embodiment of the present invention is described. In the wire harness manufacturing method according to the embodiment of the present invention, an ultrasonic welder and a jig 5 having a predetermined shape are used.

In the wire harness manufacturing method according to the embodiment of the present invention, a conventional and general ultrasonic welder (preferably, an ultrasonic spot welder, that is, an ultrasonic welder capable of welding any specific range) can be applied. Therefore, detailed description is omitted. In brief description, a general ultrasonic welder includes an ultrasonic oscillator, an ultrasonic transducer, and a horn. The ultrasonic oscillator can generate an electric signal having an ultrasonic frequency (for example, an alternating current having an ultrasonic frequency). The ultrasonic transducer oscillates with the electric signal generated by the ultrasonic oscillator to generate ultrasonic waves. The horn (a pressurizing member) is a resonant body oscillating in resonance with the ultrasonic waves generated by the ultrasonic transducer, and is a member transmitting the ultrasonic waves to a welding target. Note that while some ultrasonic welders are configured to include an anvil and pressurize and weld the welding target interposed between the horn (the pressurizing member) and the anvil, the ultrasonic welder for use in the wire harness manufacturing method according to the embodiment of the present invention may not have an anvil. That is, since the jig 5 functions as an anvil, the ultrasonic welder may not include an anvil.

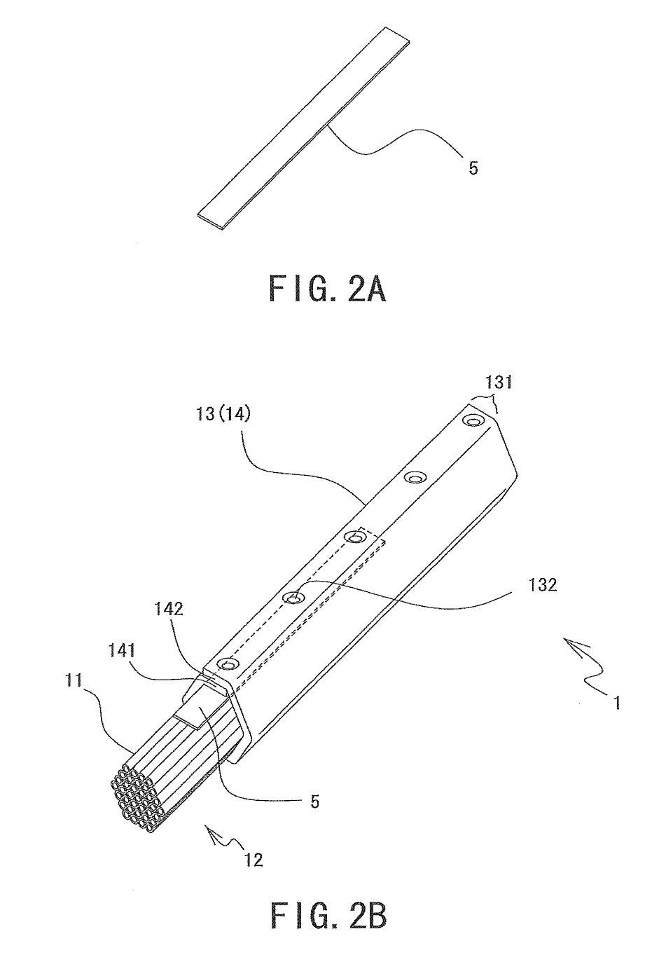

FIG. 2 shows views each schematically showing the structure of the jig 5 for use in the wire harness manufacturing method according to the embodiment of the present invention, FIG. 2(a) being an external perspective view of the jig 5 and FIG. 2(b) being a perspective view showing the state in which the jig 5 is disposed between the outer circumferential surface of the wire bundle 12 and the inner circumferential surface of the protector 13 (=the sheet-like member 14). As shown in FIGS. 2(a) and 2(b), the jig is an approximately stick-like member having a predetermined length dimension and a predetermined width dimension.

The jig 5 is a member receiving a pressure applied by the horn 6 of the ultrasonic welder in the process of bonding both of the side parts 141 and 142 of the sheet-like member 14 together. That is, with both of the side parts 141 and 142 of the sheet-like member 14 being interposed between the horn 6 of the ultrasonic welder and the jig 5, a pressure is applied to both of the side parts 141 and 142 of the sheet-like member 14. For this reason, the jig 5 has a strength enough not to be deformed (or to be hardly deformed) even when receiving a pressure from the horn 6 of the ultrasonic welder. However, the thickness dimension is preferably as small as possible. For this reason, the jig 5 is formed from, for example, a metal plate.

The width dimension of the jig 5 is set based on the dimensions and shape of the bonding part 132 of the protector 13. That is, a portion interposed between the horn of the ultrasonic welder and jig to be pressurized serves as the bonding part 132. For this reason, for example, when the dimensions and shape of the bonding part 132 cover the entire portion to be pressurized by the tip of the horn of the ultrasonic welder, the dimensions and shape of the bonding part 132 are set to be larger than the dimensions and shape of the horn 6 of the ultrasonic welder.

Note that while the jig 5 may be configured to be formed in an approximately flat plate shape as shown in FIGS. 2(a) and 2(b), the jig 5 may be configured to have a predetermined sectional shape (the sectional shape herein is a section at the right angle with respect to a longitudinal direction). That is, it is possible to apply a structure having a shape that allows the longitudinal direction of the jig 5 and the axial direction of the wire bundle 12 of the present wire harness 1 to be set approximately parallel to each other and, in this state, can be inserted between the outer circumferential surface of the wire bundle 12 of the present wire harness 1 and the inner circumferential surface of the sheet-like member 14 (=the protector 13) wound around the outer circumferential surface of the wire bundle 12 without difficulty (for example, a shape not significantly deforming the wire bundle 12 of the present wire harness 1 and the sheet-like member 14 wound around the outer circumferential surface of the wire bundle 12). In other words, it is possible to apply a structure having a shape that does not form a gap (or forms a small gap if formed) between the outer circumferential surface of the wire bundle 12 and the inner circumferential surface of the sheet-like member 14, between the jig 5 and the outer circumferential surface of the wire bundle 12, or between the jig 5 and the inner circumferential surface of the sheet-like member 14, with the jig 5 being disposed between the outer circumferential surface of the wire bundle 12 and the inner circumferential surface of the sheet-like member 14 (=the protector 13) wound around the outer circumferential surface of the wire bundle 12. Specifically, the jig is formed to have a shape approximately identical to the shape of the outer circumferential surface of the wire bundle 12 of the present wire harness 1. For example, if the structure is such that the wire bundle 12 of the present wire harness 1 has an approximately circular section, it is possible to apply a structure such that the jig is formed to have a curved surface having a radius of curvature approximately equal to a radius of a circle formed by the wire bundle 12 of the present wire harness 1.

The length dimension of the jig 5 is set based on the length dimension of the sheet-like member 14 (=the protector 13) in the axial direction of the wire bundle 12 and the position where the bonding part 132 is formed (in detail, a position in the axial direction of the wire bundle 12). Specifically, as shown in FIG. 2(b), the dimension is set so that, with the jig 15 being disposed between the outer circumferential surface of the wire bundle 12 and the sheet-like member 14 wound around the outer circumferential surface of the wire bundle 12, one end of the jig 5 can reach a position where the bonding part 132 is to be formed and the other end thereof can protrude from an end face of the sheet-like member 14. In other words, the length dimension of the jig 5 in the axial direction is set longer than a distance from one end of the sheet-like member 14 in the axial direction of the wire bundle 12 to the bonding part 132. For example, if the length dimension is set slightly longer than a half of the length of the sheet-like member 14, the bonding part 132 can be formed at any position on the sheet-like member 14 in the axial direction of the wire bundle 12.

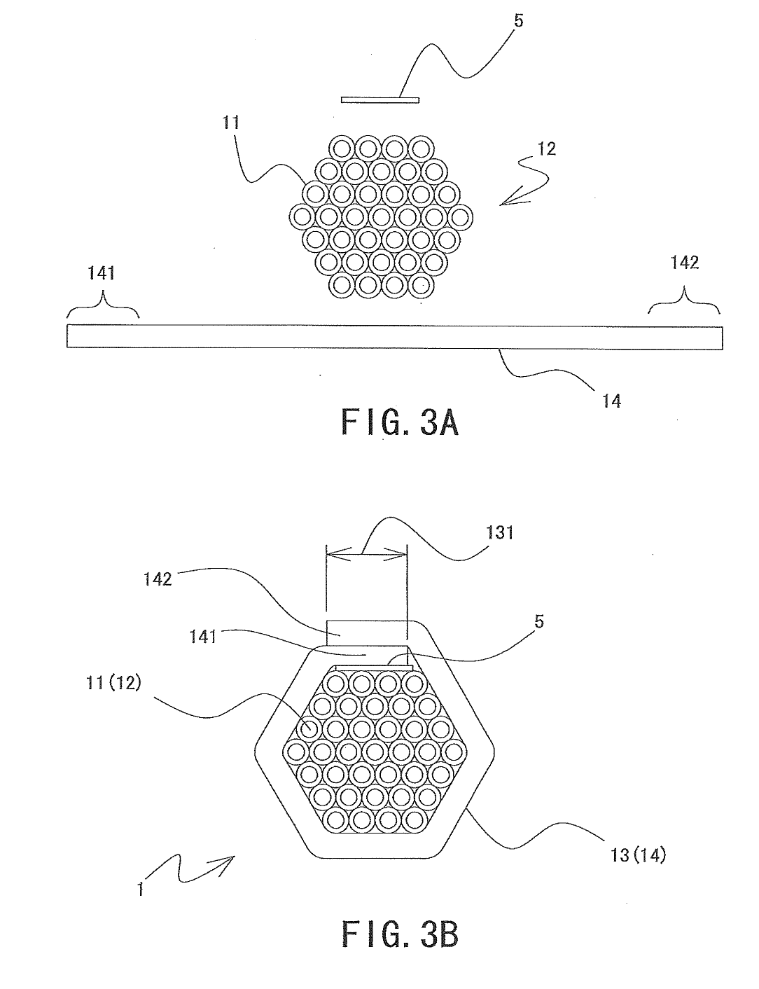

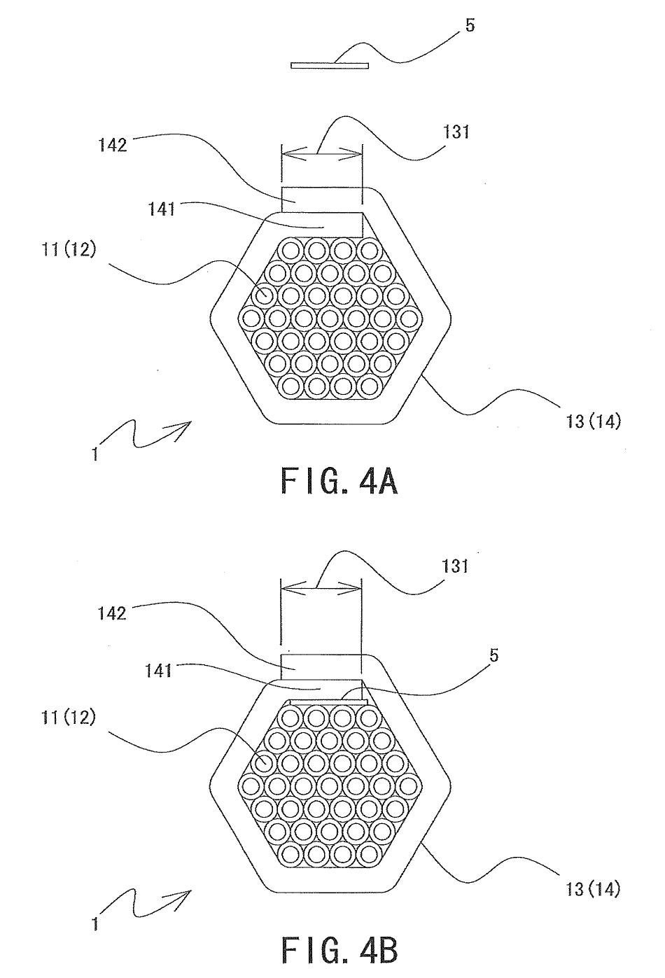

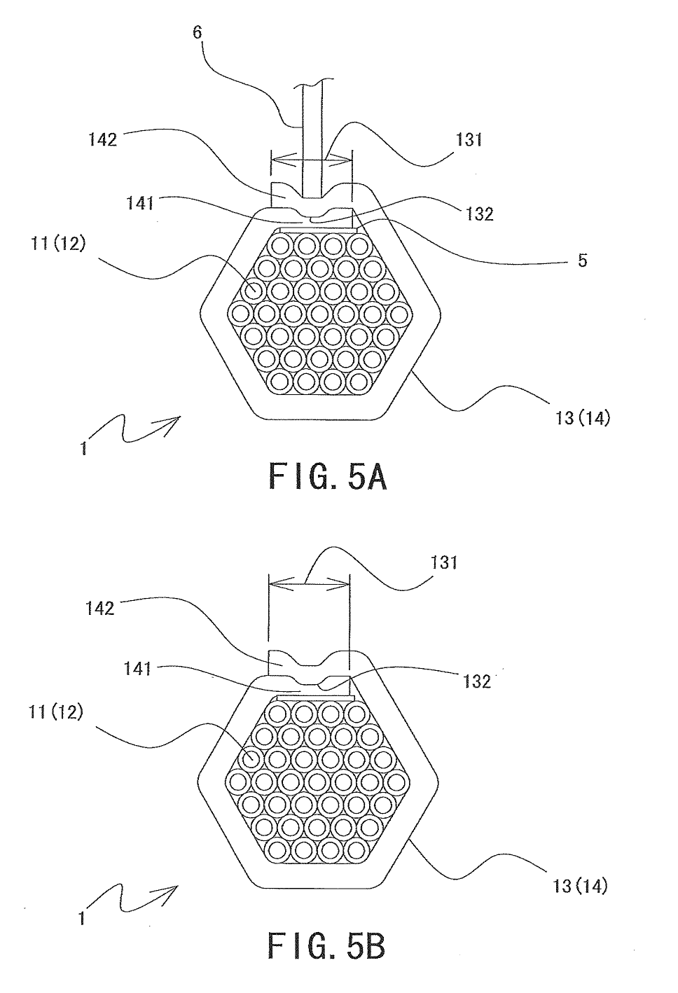

FIG. 3 to FIG. 5 show schematic sectional views schematically showing the predetermined processes of a protector manufacturing method according to an embodiment of the present invention. Specifically, FIG. 3(a) shows the state before the sheet-like member 14 is wound around the wire bundle 12, and FIG. 3(b) shows the state in which the sheet-like member 14 is wound around the wire bundle 12. FIG. 4(a) shows the state in which the sheet-like member 14 is wound around the wire bundle 12, and FIG. 4(b) shows the state in which the jig 5 is inserted between the outer circumferential surface of the wire bundle 12 and the sheet-like member 14. FIG. 5(a) shows a process of welding one side part 141 and the other side part 142 of the sheet-like member 14 together by the ultrasonic welder, and FIG. 5(b) shows the state in which welding is complete.

As shown in FIG. 3(a), the sheet-like member 14 having a predetermined width dimension is prepared. The width dimension of the sheet-like member 14 is set so that, on an outer surface of the one side part 141 of the sheet-like member 14, the other side part 142 can be superposed (=the superposed part 131 is formed) when the sheet-like member 14 is wound around the outer circumferential surface of the wire bundle 12 of the present wire harness 1. For example, when the wire bundle 12 is formed to have an approximately circular section as a whole, the sheet-like member is formed to have a width dimension longer than the length of the circumference of the circle formed by the wire bundle 12. When the wire bundle 12 is formed to have a flat plate shape (when a flat cable is formed) as a whole, the sheet-like member is formed to have a width dimension twice as long as the width dimension of the wire bundle 12. When the wire bundle 12 is formed to have an approximately polygonal section, the width dimension is set so as to be longer than a total length of sides of the polygon.

Note that the length dimension of the sheet-like member 14 is the length dimension of the protector 13. For this reason, the length dimension of the sheet-like member 14 is set based on the length of a portion of the wire bundle 12 desired to be protected by the protector 13. Also, a thickness dimension of the sheet-like member 14 is not particularly restrictive. That is, with the sheet-like member 14 being wound around the outer circumferential surface of the wire bundle 12 to form the protector 13, it is enough for the sheet-like member to have a thickness dimension allowing protection of the wire bundle 12. For this reason, the thickness dimension is set as appropriate based on the performance of the protector, the material of the sheet-like member 14, and others.

As shown in FIGS. 3(a) and 3(b), the jig 5 is first disposed at a predetermined position on the outer circumferential surface of the wire bundle 12. Then, in this state, the sheet-like member 14 is wound around the outer circumferential surface of the wire bundle 12. Here, particularly as shown in FIG. 2(b), the sheet-like member is wound so that both of the side parts 141 and 142 of the sheet-like member 14 are positioned on an outer surface of the jig (a surface opposite to a surface facing or in contact with the wire bundle 12). In other words, the sheet-like member is wound so that both of the side parts 141 and 142 of the sheet-like member 14 are superposed on the outer surface of the jig 5. With this, the superposed part 131 of the sheet-like member 14 is formed on the outer circumferential surface of the jig 5.

Note that the order may be such that the sheet-like member 14 is wound over the outer circumferential surface of the wire bundle 12 and then the jig is inserted between the outer circumferential surface of the wire bundle 12 and the inner circumferential surface of the sheet-like member 14. That is, as shown in FIG. 4(a), the sheet-like member 14 is first wound around the outer circumferential surface of the wire bundle 12. Next, as shown in FIG. 4(b), the jig is inserted between the outer circumferential surface of the wire bundle 12 and the inner circumferential surface of the sheet-like member 14. Here, as shown in FIG. 4(b), the jig 5 is inserted between the outer circumferential surface of the wire bundle 12 and a portion where both of the side parts 141 and 142 of the sheet-like member 14 are superposed (=the superposed part 131).

Next, as shown in FIGS. 5(a) and 5(b), both of the side parts 141 and 142 (=the superposed part 131) of the sheet-like member 14 are bonded by the ultrasonic welder (not shown).

Specifically, first as shown in FIG. 5(a), onto the portion where both of the side parts 141 and 142 of the sheet-like member 14 wound over the outer circumferential surface of the wire bundle 12 are superposed, the horn 6 of the ultrasonic welder is pressed from outside with a predetermined pressure. With the horn of the ultrasonic welder being pressed with the predetermined pressure onto the portion where both of the side parts 141 and 142 of the sheet-like member 14 are superposed, a predetermined portion of the portion where both of the side parts 141 and 142 of the sheet-like member 14 are superposed (at least part of the superposed portion; in the embodiments of the present invention, part of the superposed portion) is pressurized as being interposed between the horn 6 of the ultrasonic welder and the jig 5. Then, at the interposed and pressurized portion, the outer surface of the one side part 141 of the sheet-like member 14 and the inner surface of the other side part 142 are in contact with each other with a predetermined pressure.

Then, in this state, the ultrasonic welder is activated. Upon activation of the ultrasonic welder, ultrasonic vibrations are applied from the horn 6 of the ultrasonic welder to the portion of both of the side parts 141 and 142 of the sheet-like member 14 in contact with each other with the predetermined pressure (=the portion interposed between the horn 6 of the ultrasonic welder and the jig 5 and pressurized) and its nearby portion. With this, the surfaces in contact with each other with the predetermined pressure are heated therebetween with ultrasonic vibrations.

When the sheet-like member 14 is formed from a thermoplastic resin composite, the surfaces where the outer surface of the one side part 141 of the sheet-like member 14 and the inner surface of the other side part 142 are in contact with each other with the predetermined pressure and their nearby portion are heated so as to become at a temperature equal to or higher than the melting point of the resin composite. When the sheet-like member 14 is formed from a non-woven fabric having the structure described above, the surfaces where the outer surface of the one side part 141 of the sheet-like member 14 and the inner surface of the other side part 142 are in contact with each other with the predetermined pressure and their nearby portion are heated so as to become at a temperature lower than the melting point of the base fiber and the core fiber of the binder fiber and equal to or higher than the melting point of the binder component of the core fiber.

When heated to the temperature described above, the surfaces where the outer surface of the one side part 141 of the sheet-like member 14 and the inner surface of the other side part 142 are in contact with each other with the predetermined pressure and their nearby portion are molten to be bound (=welded) together. With this, the outer surface of the one side part 141 of the sheet-like member 14 and the inner surface of the other side part 142 are bound together to form the binding part 132. When the sheet-like member 14 is formed from the non-woven fabric having the structure described above and is heated to the temperature described above, the base fiber and the core fiber of the binder fiber can be bonded together with their fiber state being kept. Note that the heating temperature can be set as appropriate by adjusting the amplitude, vibration time, or others of the horn of the ultrasonic welder.

This process is performed at a predetermined position of each of both of the side parts 141 and 142 of the sheet-like member 14. For example, this process is performed at a plurality of positions with a predetermined space apart from each other along the axial direction of the wire bundle 12.

After this process is complete at all of the predetermined positions, the jig 5 is extracted from between the wire bundle 12 and the sheet-like member 14.

After these processes described above, the protector 13 formed from the sheet-like member 14 is formed at a predetermined position on the outer circumferential surface of the wire bundle 12. Then, when the protectors 13 are formed at the plurality of positions of the wire bundle 12, the processes above are repeated at each necessary position. With this, the present wire harness 1 having the structure as shown in FIG. 1 is manufactured.

When the jig 5 is configured to have the length dimension described above, the jig can be disposed at any position between the sheet-like member and the wire bundle 12. Therefore, the bonding part 132 can be formed at a predetermined position of the protector 13.

Also, when the jig 5 is configured to be in a thin plate shape and be formed in a shape modeled after the shape of the outer circumferential surface of the wire bundle 12, the dimensions and the shapes of the wire bundle 12 and the protector 13 do not change even the jig is extracted from between the wire bundle 12 and the inner circumferential surface of the protector formed. In particular, when the jig 5 is configured to be formed from a thin plate, no gap is produced between the wire bundle 12 and the protector 13 even after the jig 5 is extracted.

According to the wire harness manufacturing method of the embodiments of the present invention, in the process of bonding both of the side parts 141 and 142 of the sheet-like member 14 together, both of the side parts 141 and 142 of the sheet-like member 14 are pressurized as being interposed between the horn 6 of the ultrasonic welder and the jig 5. As described above, the jig 5 is not deformed or hardly deformed even if a pressure from the horn 6 of the ultrasonic welder is applied. For this reason, a predetermined pressure can be applied to a predetermined portion (that is, a portion serving as the bonding part 132) of both of the side parts 141 and 142 of the sheet-like member 14.

That is, in the structure in which the jig 5 is not used, when the horn 6 of the ultrasonic welder is pressed onto the outside of both of the side parts 141 and 142, the wire bundle 12 is deformed by that pressure, and the pressure becomes mitigated. For this reason, it is impossible or difficult to apply the predetermined pressure to both of the side parts 141 and 142. By contrast, in the structure in which the jig 5 is used, the jig 5 receives the pressure of the horn 6 of the ultrasonic welder. Then, part of both of the side parts 141 and 142 of the sheet-like member 14 is interposed between the horn 6 of the ultrasonic welder and the jig 5, and therefore the predetermined pressure can be applied.

For this reason, according to the wire harness manufacturing method of the embodiments of the present invention, compared with the structure in which the jig 5 is not used, the pressure to be applied to the portion where the side parts 141 and 142 of the sheet-like member 14 are superposed can be increased. Therefore, the bonding strength at the bonding part 132 can be kept or improved.

Furthermore, according to the structure in which the jig 5 is used, it is easy to control the pressure to be applied to the portion where both of the side parts 141 and 142 of the sheet-like member 14 are superposed.

That is, in the structure in which the jig 5 is not used, when the horn 6 of the ultrasonic welder is pressed from outside onto both of the side parts 141 and 142, the predetermined portion of the portion where both of the side parts 141 and 142 are superposed is pressurized as being interposed between the horn 6 of the ultrasonic welder and the wire bundle 12. Here, when the wire bundle 12 is deformed by the applied pressure, the pressure applied to the predetermined portion varies depending on the form of deformation of the wire bundle 12 (=such as the shape and dimensions after deformation). Since it is difficult to control the form of the deformation of the wire bundle 12 (in particular, to make the dimensions and shape of the section of the wire bundle 12 after deformation uniform), it is also difficult to control the pressure to be applied to the predetermined portion (in particular, to make the pressure uniform). For this reason, when bonding is performed at a plurality of positions on the portion where both of the side parts 141 and 142 are superposed, the pressure applied to the predetermined portion of both of the side parts 141 and 142 of the sheet-like member 14 is nonuniform at the time of bonding at each position and, as a result, the bonding strength at each bonding part 132 is nonuniform.

By contrast, in the structure in which the jig 5 is used, when the horn 6 of the ultrasonic welder is pressed onto the predetermined portion of both of the side parts 141 and 142 of the sheet-like member 14, the jig 5 receives the pressure applied from the horn 6 of the ultrasonic welder. Since the jig 5 is not deformed or hardly deformed if the horn 6 of the ultrasonic welder is pressed thereonto, the pressure applied to both of the side part 141, 142 of the sheet-like member 14 is uniform. Therefore, the bonding strength at each bonding part 132 can be made uniform. As a result, the quality of the present wire harness 1 is stabilized, and quality control is facilitated.

Also, according to the wire harness manufacturing method of the embodiments of the present invention, the surface of the wires 11 configuring the wire bundle 12 of the wire harness 1 is heated by heat transfer, but its temperature increase is small. For this reason, the coating component of the wires 11 is not damaged. Therefore, the function of the coating component of the wires 11 for protecting and insulating a conductor is not degraded or lost. Furthermore, in the process of bonding both of the side parts 141 and 142 of the sheet-like member 14 together, the wires 11 are not pressurized, thereby preventing the wires 11 from being damaged by the applied pressure. Therefore, reliability of the present wire harness 1 can be kept or improved.

As such, while a structure is achieved in which a portion protruding outward is not formed on the protector 13, a decrease in bonding strength at the bonding part 132 can be prevented or the bonding strength can be improved.

Furthermore, according to the wire harness manufacturing method of the embodiments of the present invention, the superposed part 131 of the protector 13 is formed along and over the outer circumferential surface of the wire bundle 12. For this reason, while it is required to cut out (=trim) an unnecessary portion after bonding in a conventional structure in which the superposed part (=the bonding part) is configured to protrude outward, this process is not required in the wire harness manufacturing method according to the embodiments of the present invention. Therefore, a reduction in the number of manufacturing processes and a reduction in manufacturing cost can be achieved.

While the embodiments of the present invention have been described in detail above, the present invention is not meant to be restricted to the embodiments described above, and can be variously modified within a range not deviating from the gist of the present invention.

For example, while the structure is shown in the embodiments described above in which the protector is formed from a non-woven fabric, the material of the protector is not restricted to a non-woven fabric. The material and structure are not restrictive as long as the material can be welded by an ultrasonic welder. That is, any various known thermoplastic resin composites can be applied as long as it is a resin composite. Also, the structure of the sheet-like member is not restricted to the one made of a non-woven fabric.

Also, while the structure is shown in the embodiments of the present invention described above in which the bonding part 132 is formed at part of the portion where both of the side parts 141 and 142 of the sheet-like member 14 are superposed, the bonding part 132 may be formed not at part but the entirety thereof. In short, the structure can be any as long as the bonding part 132 is formed at least at part of the superposed portion.

Furthermore, while the structure is shown in the embodiments of the present invention described above in which the protector 13 is formed on the outer circumferential surface of the wire bundle 12 formed from the plurality of wires 11, the structure may be such that the protector is formed on the outer circumferential surface of a single wire. In this case, “the outer circumferential surface of the wire bundle 12” is read as “the outer circumferential surface of the single wire” in the embodiments described above.

1. A wire harness manufacturing method comprising the steps of:
winding a sheet-like member around an outer circumferential surface of a predetermined portion of a wire and superposing both of side parts of the sheet-like member on a portion on an outer circumferential surface of a predetermined portion of the wire; and
disposing a jig between the outer circumferential surface of the predetermined portion of the wire and an inner circumferential surface of the superposed portion of the sheet-like member and pressurizing and welding at least part of the superposed portion of the sheet-like member by a pressurizing member of a welder.

2. The wire harness manufacturing method according to claim 1, wherein the welder is an ultrasonic welder, the sheet-like member is made of an ultrasonically-weldable material, and ultrasonic vibrations are provided while at least part of the superposed portion of the sheet-like member is being pressurized.

3. The wire harness manufacturing method according to claim 1, wherein the jig is a flat plate or an approximately stick-like member having an arc-shaped section along a shape of the outer circumferential surface, and has a predetermined length in an axial direction of the wire.

4. The wire harness manufacturing method according to claim 1, wherein the jig is disposed in advance on the outer circumferential surface of the predetermined portion of the wire before the sheet-like member is wound around the predetermined portion of the wire, and the sheet-like member has both of the side parts superposed on an outer circumferential surface of the jig.

5. The wire harness manufacturing method according to claim 1, wherein the jig is inserted between the outer circumferential surface of the predetermined portion of the wire and the inner circumferential surface of the superposed portion of the sheet-like member after the sheet-like member is wound around the outer circumferential surface of the predetermined portion of the wire.
